(19) United States
(12) Patent Application Publication
(10) Pub. No.: US 2022/0128988 A1
(43) Pub. Date: Apr. 28, 2022

(54) LEARNING APPARATUS AND METHOD, PREDICTION APPARATUS AND METHOD, AND COMPUTER READABLE MEDIUM

(71) Applicant: NEC Corporation, Minato-ku, Tokyo (JP)

(72) Inventors: Azusa SAWADA, Tokyo (JP); Takashi SHIBATA, Tokyo (JP); Katsuhiko TAKAHASHI, Tokyo (JP)

(73) Assignee: NEC Corporation, Minato-ku, Tokyo (JP)

(21) Appl. No.: 17/431,261

(22) PCT Filed: Feb. 19, 2019
(86) PCT No.: PCT/JP2019/005848

§ 371 Date: Aug. 16, 2021

(51) Int. Cl. G05B 23/02

(52) U.S. Cl. CPC G05B 23/0283; G05B 23/0254; G05B 23/0235

(57) ABSTRACT

A data-series group includes data series which is a series of data obtained by observing the same object at discrete times. Time labels are time information added to respective data included in the data-series group. State labels are added to some of the data included in the data-series group. A loss-function control unit determines a loss function to be used for learning based on the time labels and the state labels. A threshold is used to adjust a branch condition of the loss-function control unit. A regressor is a model, and is used to detect an abnormality or predict a remaining life span. A dictionary stores parameters of the regressor. A regressor training unit trains the regressor based on the loss function determined by the loss-function control unit.

### TECHNICAL FIELD

The present disclosure relates to a learning apparatus, a method, and a computer readable medium, and in particular, to a learning apparatus, a method, and a computer readable medium for creating a model for estimating, for example, a state of an object to be observed.

The present disclosure relates to a prediction apparatus, a method, and a computer readable medium, and in particular, to a prediction apparatus, a method, and a computer readable medium for estimating, for example, a state of an object to be observed.

### BACKGROUND ART

In the management of a structure, a plant, or the like, it is required to appropriately carry out inspections and maintenance so that an abnormality such as deterioration or a failure does not occur in any part thereof. In the past, as a standard method for carrying out inspections and maintenance, it has been common to carry out them at regular intervals. In contrast, in recent years, the standard method for carrying out inspections and maintenance has shifted to those in which they are carried out based on the state of each part. In particular, if it is possible to find out, for each part, the period of time before any failure or the like of that part by using the prediction of a remaining life span thereof before some measures are surely required, it is possible to prevent inspections and replacement from being excessively carried out. Further, it is possible to take measures for one part to another in descending order of the priority.

Patent Literature 1 discloses, as related art, a predictive-sign diagnosis system that predicts an abnormality in a plant or the like and calculates a remaining life span thereof. The predictive-sign diagnosis system disclosed in Patent Literature 1 acquires sensor data from a plurality of sensors installed in a machinery facility in the form of time-series data, and calculates a state measure which is an index indicating the state of the machinery facility such as an abnormality and performance thereof by using a statistical method using the acquired time-series data as learning data. The predictive-sign diagnosis system calculates an approximate expression approximately representing the transition of the state measure from the past to the present time by using a polynomial expression, and estimates a state measure up to a predetermined time point in the future by using the approximate expression. In Patent Literature 1, the period of time from the present time to a time at which the estimated state measure reaches a threshold is calculated as the remaining life span.

### CITATION LIST

### Patent Literature

### Patent Literature 1: Japanese Patent No. 5827425

### SUMMARY OF INVENTION

### Technical Problem

In Patent Literature 1, a transition in regard to abnormalities and deterioration in performance in the future is estimated based on the transition in regard to them in the past. However, in Patent Literature 1, for example, until an abnormality that can be detected by the used index occurs, it is impossible to calculate the remaining life span, therefore making it impossible to predict an abnormality at an early stage.

In view of the above-described circumstances, an object of the present disclosure is to provide a learning apparatus, a method, and a computer readable medium capable of creating a model by which an abnormality can be predicted at an early stage.

Further, another object of the present disclosure is to provide a prediction apparatus, a method, and a computer readable medium capable of predicting an abnormal state or the like by using a model by which an abnormality can be predicted at an early stage.

### Solution to Problem

In order to achieve the above-described object, the present disclosure provides a learning apparatus including: a data-series group including a data series, the data series being a series of data obtained by observing the same object at discrete times; time labels, the time labels being pieces of time information each of which is added to a respective one of data included in the data-series group; a state label added to at least one of the data included in the data-series group; a loss-function control unit configured to determine a loss function to be used for learning based on the time labels and the state label; a threshold for adjusting a branch condition of the loss-function control unit; a model configured to detect an abnormality or predicting a remaining life span; a dictionary configured to store a parameter of the model; and a training unit configured to train the model based on the loss function determined by the loss-function control unit.

Further, the present disclosure provides a learning method including: determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group; and learning a parameter of a model for detecting an abnormality or predicting a remaining life span based on the determined loss function.

The present disclosure also provides a computer readable medium storing a program for causing a computer to perform processes including: determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group; and learning a parameter of a model for detecting an abnormality or predicting a remaining life span based on the determined loss function.

The present disclosure also provides a prediction apparatus including: an abnormality prediction model by which an abnormality is detected or a remaining life span is predicted by using a parameter of a model, the model having been trained by using the above-described learning apparatus; and a threshold, in which the prediction apparatus is configured to output, for normal data or data having a remaining life span longer than a predetermined value, a value exceeding the threshold, and predict, for abnormal data having a remaining life span equal to or shorter than the threshold, a remaining life span.

The present disclosure also provides a prediction method including: detecting an abnormality or predicting a remaining life span by using a model, the model having been trained by determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group, and learning a parameter of a model for detecting an abnormality or predicting a remaining life span based on the determined loss function; and outputting, for normal data or data having a remaining life span longer than a predetermined value, a value exceeding the threshold, and predicting, for abnormal data having a remaining life span equal to or shorter than the threshold, a remaining life span.

The present disclosure also provides a computer readable medium storing a program for causing a computer to perform processes including: detecting an abnormality or predicting a remaining life span by using a model, the model having been trained by determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group, and learning a parameter of a model for detecting an abnormality or predicting a remaining life span based on the determined loss function; and outputting, for normal data or data having a remaining life span longer than a predetermined value, a value exceeding the threshold, and predicting, for abnormal data having a remaining life span equal to or shorter than the threshold, a remaining life span.

### Advantageous Effects of Invention

A learning apparatus, a method, and a computer readable medium according to the present disclosure can create a model by which an abnormality or the like can be predicted at an early stage.

Further, a prediction apparatus, a method, and a computer readable medium according to the present disclosure can predict an abnormal state or the like by using a model by which an abnormality or the like can be predicted at an early stage.

### BRIEF DESCRIPTION OF DRAWINGS

FIG. 1 is a block diagram showing a learning apparatus according to a first example embodiment of the present disclosure;

FIG. 2 schematically shows data series included in a data-series group, time labels, state labels, and results of regressions in which a loss function has a zero value;

FIG. 3 is a flowchart showing an operation procedure of a learning apparatus;

FIG. 4 is a block diagram showing a learning apparatus according to a second example embodiment of the present disclosure;

FIG. 5 is a block diagram showing an abnormality prediction apparatus; and

FIG. 6 is a block diagram showing an example of a configuration of an information processing apparatus.

### DESCRIPTION OF EMBODIMENTS

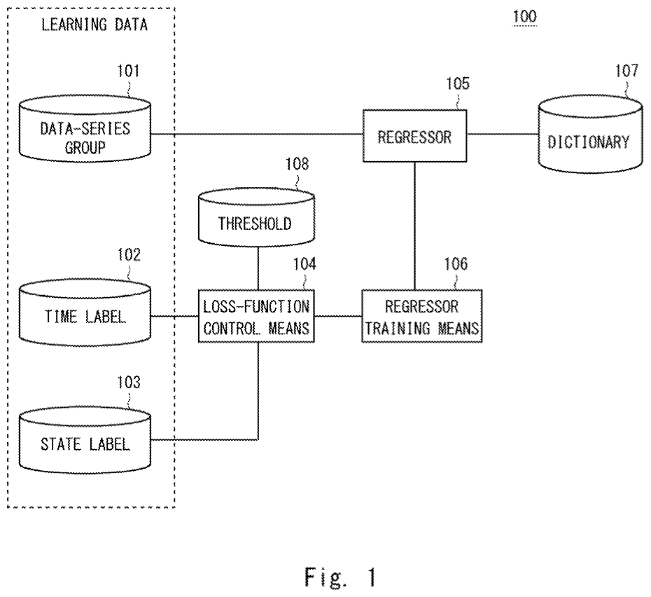

Example embodiments according to the present disclosure will be described hereinafter with reference to the drawings. FIG. 1 shows a model creation apparatus (a learning apparatus) according to a first example embodiment of the present disclosure. A learning apparatus 100 includes a data-series group 101, time labels 102, state labels 103, loss-function control means 104, a regressor 105, regressor training means 106, a dictionary 107, and a threshold 108.

The data-series group 101 is composed of a series of data obtained by observing the same object in a discrete manner. The data-series group 101 is a set of data acquired as a series of data by observing the same object at discrete times or under discrete conditions. Note that the term “discrete” is not limited to continuous (i.e., successive) and equally-spaced times like those of video images, and includes photographing (or filming) at discontinuous times, discontinuous dates and times, or discontinuous years (or eras). For example, the data-series group 101 may include image data obtained by photographing (or filming) the same organ of the same patient at different dates and times.

Note that the data acquired as data in the same series is not limited to data for the same object, and may include an area that does not correspond to the same object. The data acquired as data in the same series can include an area that does not correspond to the same object as long as a correspondence relation between data, such as a correspondence relation between positions on images, can be obtained by using an existing technique or the like. In such a case, it is conceivable to use the data-series group 101 while dividing it so that corresponding areas constitute data in the same series. Each data is not limited to the image data, and may be a group of indexes that are possibly effective for the detection of an abnormality, a time-series signal having a certain time width, or data obtained by combining them.

The time labels 102 are pieces of time information added to a respective one of data (i.e., pieces of data) included in the data-series group. Each of the time labels 102 indicates a time at which each data in each data series included in the data-series group 101 was acquired. A remaining life span at the time at which the data was acquired can be calculated based on the values of the time labels 102, and the time labels 102 can be used for learning.

The state labels 103 are labels that are added to some of the data included in the data-series group, and indicate states. Each of the state labels 103 indicates label data that is added to data included in the data-series group 101 and indicates whether or not the data is abnormal. A correct-answer label is a class in which an object to be detected as an abnormality such as a defect or a lesion is defined as a positive example, and a normal state is defined as a negative example, or is a set of such classes in which each of the classes is associated with a respective area in the data. Note that there may be a plurality of types of positive examples. The state labels 103 do not necessarily have to be attached to all the data included in the same series. It is assumed that the state labels 103 are added at least to data having the largest time label 102 and to the positive examples.

Note that, in the case of a data series including data in which the state labels 103 are positive examples, it is possible to define a remaining life span of each data by tracing back by using the time label 102 of data that became the first positive example in the series as a reference. The remaining life span cannot be defined for a data series that include no data in which the state label 103 is a positive example. However, a loss function used for learning is defined by using the loss-function control means 104 (which will be described later).

The loss-function control means 104 determines a loss function to be used for learning based on the values of the time labels 102 and the state labels 103. The loss-function control means 104 controls the loss function used for the learning so that, for example, an abnormality is detected or a remaining life span is predicted within a range in which the presence/absence of an abnormality or a remaining life span can be predicted. The regressor 105 includes a model for predicting a remaining life span from data. The regressor training means 106 is training means, and optimizes the regressor 105 based on the loss function obtained by the loss-function control means 104. Parameters of the regressor 105, which are adjusted by the regressor training means 106, are stored in the dictionary 107. A threshold for adjusting a branch condition of the loss-function control means 104 is stored in the threshold (threshold storage means) 108.

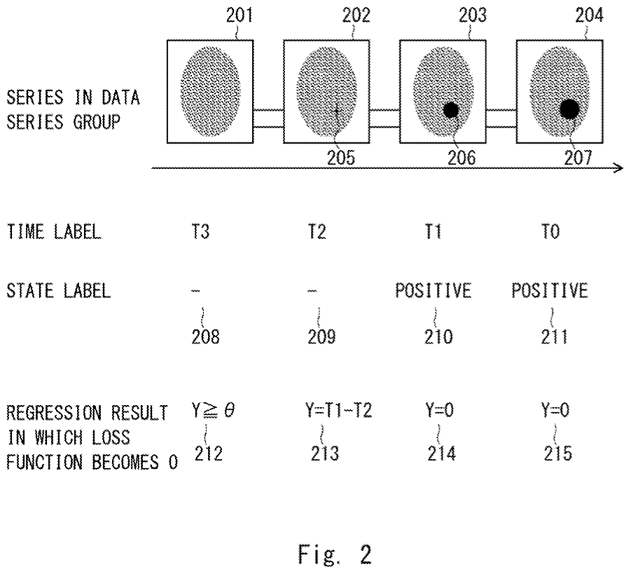

FIG. 2 schematically shows data series included in the data-series group, time labels, state labels, and results of regressions in which the loss function has a zero value. A series including positive-example data included in the data-series group 101 is composed of, for example, a plurality of data such as data 201 to 204 shown in FIG. 2. The data 201 to 204 are data that are obtained by observing changes in the same object over time. Labels T3 to T0, which are the time labels 102, are added to the data 201 to 204, respectively. Meanwhile, labels 208 to 211, which are the state labels 103, are added to all or some of the data.

In FIG. 2, the data 203 and 204 include features 206 and 207, respectively, which indicate an abnormality. The data 203 and 204 are regarded as positive examples because they include the features 206 and 207, respectively, and therefore labels 210 and 211, which indicate positive examples, are added thereto. In this example, adjacent data 202 includes a predictive sign 205 of the abnormality. However, at the time when the data 202 was acquired, it was at a predictive-sign stage, so no positive label was added to the data 202.

As shown by expressions 212 to 215 in FIG. 2, for each of the data 201 to 204, a loss function controlled by the loss-function control means 104 has a minimum value “0” for a predicted value Y of the regressor 105. In FIG. 2, θ represents the threshold 108. The expressions 212 to 215 correspond to objective variables of the regressor 105. For the data 202 having the predictive sign, the time label T1 of the data 203, in which the abnormality has occurred, is defined as a reference, and a remaining life span T1-T2 is an objective variable. Meanwhile, in the data 201 before the predictive sign of the abnormality appears, it is difficult to predict a remaining life span. Therefore, it is replaced by a loss in which it is satisfactory as long as the value is equal to or larger than the threshold θ.

For an abnormal data series included in the data-series group 101, the loss-function control means 104 converts the time label 102 into a remaining life span T. When the obtained remaining life span T is equal to or shorter than the threshold 108 (which will be described later), the loss-function control means 104 returns a regression loss function in which the remaining life span T is an objective variable. When this is not the case, the loss-function control means 104 returns a one-sided loss function that has a positive value only for a prediction below the threshold 108, and has a zero value for a prediction equal to or higher than the threshold 108. That is, the loss-function control means 104 sets a problem in which, for data having a remaining life span equal to or shorter than the threshold 108, the remaining life span is regressed. The loss-function control means 104 causes the regressor training means 106 (which will be described later) to learn so that an arbitrary numerical value exceeding the threshold 108 is returned for data having a remaining life span exceeding the threshold 108 or data of a normal series.

Specifically, regarding the loss function L, it can be selected, for example, as follows:

L(Y,θ)=(Y−T)² when C=1 and T≤θ

L(Y,θ)=max(0,θ−Y) when C=0 or T>θ

where θ is a threshold; Y is an output of the regressor unit; and T is a remaining life span.
Note that C represents a logical value indicating whether or not a positive example is included in the series. The order (i.e., the dimension) of the loss function may be changed, and the loss function may be one that is modified so that an error is allowed according to the accuracy of the prediction to be obtained.

The regressor 105 receives a set of data or their feature values as an input, and predicts a remaining life span when an abnormality is expected. The output of the regressor 105 is a numerical value corresponding to the remaining life span, which is trained so that its output higher than or equal to the threshold 108 (which will be described later) indicates a normal state. Further, when data is associated with a different state label on an area-by-area basis, the regressor 105 may make a prediction for each area, and create a heat map or detect an area based on the result of prediction.

The regressor training means 106 generates (optimizes) parameters of the regressor 105 based on a combination of the loss function determined by the loss-function control means 104 and the data included in the data-series group 101. As a result of the training by the regressor training means 106, it is possible to evaluate the accuracy of the classification (a performance index) by using the residual and the threshold. The regressor training means 106 may provide the accuracy of the classification to the loss-function control means 104 in order to adjust the threshold parameter based on the value thereof.

In the case where the regressor 105 is a neural network or the like, the regressor training means 106 optimizes the parameters by a gradient method so that the loss function is minimized. The model used for the regressor 105 is arbitrarily determined. For example, an SVR (Support Vector Regression) or a random forest is used as the model. The regressor training means 106 adopts an optimization method corresponding to the model of the regressor 105.

The dictionary 107 records therein the parameters of the regressor 105. The regressor training means 106 updates the parameters stored in the dictionary 107. When the regressor 105 is a neural network, the dictionary 107 holds weights, biases, and the like therein. The parameters recorded in the dictionary 107 are referenced to during the operation of the regressor 105.

The threshold 108 is a parameter representing a boundary of the branch by the loss-function control means 104. Regarding the optimization, it is adjusted, for example, by performing grid searching and determining whether or not the value is excessive based on the performance index of the regressor 105 obtained from the regressor training means 106. Specifically, the optimization is performed as follows. When the threshold is increased, that is, when the range of values of the remaining life span in which the loss function is a regression of the remaining life span T is expanded, if it is excessively expanded, the remaining life span is predicted even for data at a time at which there is no difference from the normal data. However, such a prediction is difficult. Therefore, in the regressor 105, which is obtained as a result of the training, the accuracy of the classification or the accuracy of the prediction of a remaining life span for learning data or verification data deteriorates, so that the increase of the threshold may be stopped at the point when deterioration of a certain level or worse occurs. Further, in the optimization of the regressor training means 106, a penalty term for increasing the threshold 108 may be added in the loss function, and the threshold may be optimized at the same time when the regressor is optimized. Further, when it is considered that there are a plurality of abnormal classes, a plurality of thresholds may be held and selectively used according thereto.

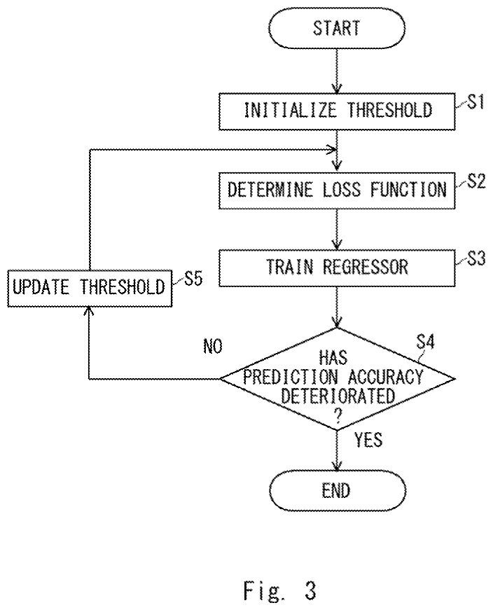

Next, an operation procedure will be described. FIG. 3 shows an operation procedure (a learning method) performed by the learning apparatus 100. The loss-function control means 104 initializes the threshold 108 (Step S1). The loss-function control means 104 determines a loss function for each data series included in the data-series group 101 based on the time labels 102 and the state labels 103 (Step S2).

The regressor training means 106 trains the regressor 105 by using a combination of the obtained loss function and data included in the data-series group 101, and updates the dictionary 107 (Step S3). The regressor training means 106 evaluates, based on the obtained result of the learning, whether or not the threshold used at that point of time has excessively increased (Step S4). In the step S4, the regressor training means 106 evaluates whether or not the threshold has excessively increased by, for example, determining whether or not the accuracy of the prediction, which is obtained as a result of the learning, has deteriorated beyond a predetermined accuracy of the prediction.

When the accuracy of the prediction has not deteriorated, the regressor training means 106 updates the threshold 108 so as to expand the range in which a remaining life span is predicted (Step S5). After that, the process returns to the step S2, and the loss-function control means 104 determines a loss function. When the regressor training means 106 determines that the accuracy of the prediction has deteriorated, it fixes the threshold at that point of time or restores the threshold to a value immediately before that point of time. Then, if necessary, the regressor training means 106 re-trains the regressor 105 and finishes the process.

In this example embodiment, the loss-function control means 104 controls the loss function so that the regression of a remaining life span is learned in a range in which a remaining life span can be predicted, and a certain value or larger is returned for normal data or data in a range in which a remaining life span cannot be predicted. The regressor training means 106 adjusts the value of the remaining life span at the boundary between these ranges as the threshold 108. It is possible to detect an abnormality at an early stage by optimizing the threshold 108 in such a manner that the threshold 108 increases within a range in which the accuracy of the prediction of the regressor 105 does not deteriorate.

In this example embodiment, instead of predicting the transition of the pre-selected abnormality level by performing extrapolation, it is handled as a prediction from a single data. Further, by introducing a parameter(s) for controlling the earliness of the prediction, it is possible to learn the earlier prediction of an abnormality and the extraction of features effective therefor. Therefore, the learning apparatus 100 can train the regressor 105 capable of predicting an abnormality and estimating a remaining life span as early as possible.

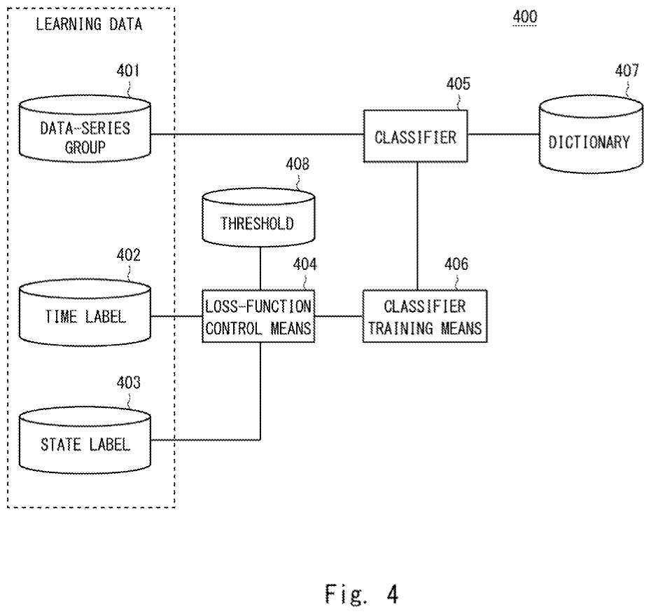

Next, a second example embodiment according to the present disclosure will be described. FIG. 4 shows a model creation apparatus (a learning apparatus) according to the second example embodiment of the present disclosure. A learning apparatus 400 includes a data-series group 401, time labels 402, state labels 403, loss-function control means 404, a classifier 405, classifier training means 406, a dictionary 407, and a threshold 408.

Note that in the case where the required accuracy is determined in advance in the prediction of a remaining life span, it is possible to handle it as the classification of ordered classes instead of handling as the regression. That is, a remaining life span may be divided into bins having an appropriate width, and each of the bins may be associated with a correct answer as a class. In such a case, instead of the regressor 105 and the regressor training means 106 shown in FIG. 1, the classifier 405 and the classifier training means 406 are used. Other features may be similar to those in the first example embodiment.

In the learning apparatus 400, the loss-function control means 404 divides a remaining life span into bins each having a predetermined size, and determines a boundary between a range in which they are handled as normal classes and a range in which they are not handled as normal classes according to the threshold 408. Then, the loss-function control means 404 converts the loss function to be used into a form in which mixture between classes in the range in which they are handled as normal classes is permitted. The loss-function control means 403 may change, for example, cross entropy used in class classification into a form in which classes in the range in which they are handled as normal classes are not distinguished from each other. Similarly to the threshold 108 in the first example embodiment, the threshold 408 is adjusted in such a manner that the threshold 408 increases within a range in which the accuracy of the prediction of the classifier 405 does not deteriorate. Even when the above-described learning apparatus 400 is used, advantageous effects similar to those by the first example embodiment can be obtained.

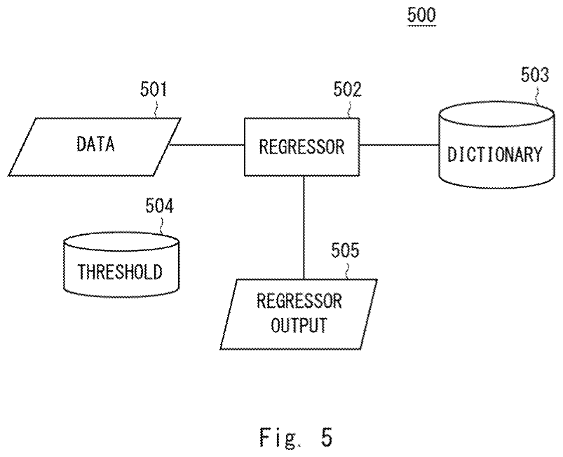

Note that the regressor 105 trained by using the learning apparatus 100 shown in FIG. 1 can be used for an abnormality prediction apparatus. FIG. 5 shows an abnormality prediction apparatus (a prediction apparatus). An abnormality prediction apparatus 500 includes a regressor 502, a dictionary 503, and a threshold 504. Data 501 is input to the regressor 502. The data 501 has the same format as that of each data included in the series in the data-series group 101 shown in FIG. 1. The classifier 405 trained by the learning apparatus 400 may be used in place of the regressor 502.

The regressor 502 outputs a regression output 505 in response to the input data 501 while taking the parameters stored in the dictionary 503 into consideration. The regression output 505, in a combination with threshold 504, may be interpreted as follows. Regarding the regression output 505 exceeding the threshold 504, it is normal data or data having a sufficiently long remaining life span. On the other hand, regarding the regression output 505 equal to or smaller than the threshold 504, it is abnormal data, and is a result of a prediction that the remaining life span will be a numerical value corresponding to the regression output 505. The abnormality prediction apparatus 500 performs such an operation that it outputs a value exceeding the threshold 504 for normal data or data having a remaining life span longer than a predetermined value, and predicts a remaining life span for abnormal data having a remaining life span equal to or shorter than the threshold.

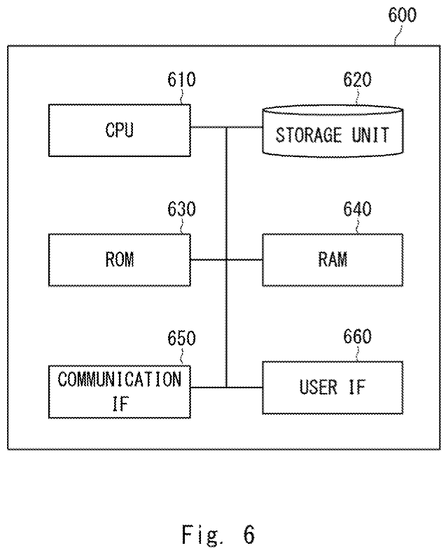

Each of the above-described learning apparatuses 100 and 400, and the abnormality prediction apparatus 500 can be formed as a computer apparatus. FIG. 6 shows an example of a configuration of an information processing apparatus (a computer apparatus) that can be used for the learning apparatus 100 or 400, or the abnormality prediction apparatus 500. An information processing apparatus 600 includes a control unit (CPU: central processing unit) 610, a storage unit 620, a ROM (Read Only Memory) 630, a RAM (Random Access Memory) 640, a communication interface (IF: Interface) 650, and a user interface 660.

The communication interface 650 is an interface for connecting the information processing apparatus 600 with a communication network through wired communication means or wireless communication means. The user interface 660 includes a display unit such as a display apparatus. Further, the user interface 660 includes an input unit such as a keyboard, a mouse, and a touch panel.

The storage unit 620 is an auxiliary storage device capable of storing various types of data. The storage unit 620 does not necessarily have to be a part of the information processing apparatus 600, and may be an external storage device or a cloud storage connected to the information processing apparatus 600 through a network. The storage unit 620 may be used, for example, to store the data-series group 101, the time labels 102, and the state labels 103 shown in FIG. 1. Further, the storage unit 620 can also be used as the dictionary 107. The ROM 630 is a nonvolatile storage device. For the ROM 630, for example, a semiconductor storage device such as a flash memory having a relatively small capacity is used. A program(s) executed by the CPU 610 can be stored in the storage unit 620 or the ROM 630.

The aforementioned program can be stored and provided to the information processing apparatus 600 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 640 is a volatile storage device. As the RAM 640, various types of semiconductor memory apparatuses such as a DRAM (Dynamic Random Access Memory) or an SRAM (Static Random Access Memory) can be used. The RAM 640 can be used as an internal buffer for temporarily storing data and the like. The CPU 610 develops (i.e., loads) a program stored in the storage unit 620 or the ROM 630 in the RAM 640, and executes the developed (i.e., loaded) program. For example, functions such as the loss-function control means 104, the regressor 105, and the regressor training means 106 shown in FIG. 1 are implemented by having the CPU 610 execute the program.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, the whole or a part of the embodiments disclosed above can be described as, but not limited to, the following supplementary notes.

[Supplementary Note 1]

a data-series group including a data series, the data series being a series of data obtained by observing the same object at discrete times;

time labels, the time labels being pieces of time information each of which is added to a respective one of data included in the data-series group;

a state label added to at least one of the data included in the data-series group;

a loss-function control unit configured to determine a loss function to be used for learning based on the time labels and the state label;

a threshold for adjusting a branch condition of the loss-function control unit;

a model configured to detect an abnormality or predicting a remaining life span;

a dictionary configured to store a parameter of the model; and

a training unit configured to train the model based on the loss function determined by the loss-function control unit.

[Supplementary Note 2]

The learning apparatus described in Supplementary note 1, wherein the loss-function control unit controls a loss function to be used for learning in such a manner that an abnormality is detected or a remaining life span is predicted within a range in which presence/absence of an abnormality or a remaining life span can be predicted.

[Supplementary Note 3]

The learning apparatus described in Supplementary note 1 or 2, wherein

the data-series group includes data in which the state label is a positive example, and the model is a model for predicting a remaining life span, and

when a remaining life span of each data defined by tracing back by using a time label of data that became a first positive example in the data-series group as a reference is equal to or longer than the threshold, the loss-function control unit defines, as the loss function to be used for the learning, a loss function in which the remaining life span is an objective variable, and

in the case where the remaining life span is shorter than the threshold, the loss-function control unit defines, as the loss function to be used for the learning, a loss function that has a positive value when a value of a remaining life span predicted by using the model is smaller than the threshold and has a zero value when the value is equal to or larger than the threshold.

[Supplementary Note 4]

The learning apparatus described in Supplementary note 1 or 2, wherein

the data-series group includes data in which the state label is a positive example, and the model is a model for predicting a remaining life span, and

when a remaining life span of each data defined by tracing back by using a time label of data that became a first positive example in the data-series group as a reference is represented by T; a value of a remaining life span predicted by using the model is represented by Y; a logical value indicating whether or not data of a positive example is included in the data series is represented by C; and the threshold is represented by θ,

the loss-function control unit defines, as the loss function to be used for the learning, a loss function that has a value corresponding to a difference between Y and T when C=1 and T≤θ, and has a larger one of a value “0” and a value “θ−Y” when C=0 and T>θ.

[Supplementary Note 5]

The learning apparatus described in any one of Supplementary notes 1 to 4, wherein the learning unit searches for the threshold based on a performance index of the model.

[Supplementary Note 6]

The learning apparatus described in Supplementary note 5, wherein the learning unit increases the threshold within a range in which the performance index does not decrease below a predetermined performance index.

[Supplementary Note 7]

A learning method comprising:

determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group; and

learning a parameter of a model for detecting an abnormality or predicting a remaining life span based on the determined loss function.

[Supplementary Note 8]

A computer readable medium storing a program for causing a computer to perform processes including:

determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group; and

learning a parameter of a model for detecting an abnormality or predicting a remaining life span based on the determined loss function.

[Supplementary Note 9]

A prediction apparatus comprising:

an abnormality prediction model by which an abnormality is detected or a remaining life span is predicted by using a parameter of a model, the model having been trained by using a learning apparatus described in any one of Supplementary notes 1 to 6; and

a threshold, wherein

the prediction apparatus is configured to output, for normal data or data having a remaining life span longer than a predetermined value, a value exceeding the threshold, and predict, for abnormal data having a remaining life span equal to or shorter than the threshold, a remaining life span.

[Supplementary Note 10]

A prediction method comprising:

detecting an abnormality or predicting a remaining life span by using a model, the model having been trained by determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group, and learning a parameter of a model for detecting an abnormality or predicting a remaining life span based on the determined loss function; and

outputting, for normal data or data having a remaining life span longer than a predetermined value, a value exceeding the threshold, and predicting, for abnormal data having a remaining life span equal to or shorter than the threshold, a remaining life span.

[Supplementary Note 11]

A computer readable medium storing a program for causing a computer to perform processes including:

detecting an abnormality or predicting a remaining life span by using a model, the model having been trained by determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group, and learning a parameter of a model for detecting an abnormality or predicting a remaining life span based on the determined loss function; and

outputting, for normal data or data having a remaining life span longer than a predetermined value, a value exceeding the threshold, and predicting, for abnormal data having a remaining life span equal to or shorter than the threshold, a remaining life span.

### REFERENCE SIGNS LIST

100, 400 LEARNING APPARATUS
101, 401 DATA SERIES
102, 402 TIME LABEL
103, 403 STATUS LABEL
104, 404 LOSS-FUNCTION CONTROL MEANS
105 REGRESSION UNIT
106 REGRESSION-UNIT LEARNING MEANS
107, 407 DICTIONARY
108, 408 THRESHOLD
405 CLASSIFICATION UNIT
406 CLASSIFICATION-UNIT LEARNING MEANS
500 ABNORMALITY PREDICTION APPARATUS
501 DATA
502 REGRESSION UNIT
503 DICTIONARY
504 THRESHOLD
505 REGRESSION OUTPUT
550 COMMUNICATION INTERFACE
560 USER INTERFACE

What is claimed is:

1. A learning apparatus comprising:
hardware, including a processor and memory;
a data-series group including a data series, the data series being a series of data obtained by observing the same object at discrete times;
time labels, the time labels being pieces of time information each of which is added to a respective one of data included in the data-series group;
a state label added to at least one of the data included in the data-series group;
a loss-function control unit implemented at least by the hardware and configured to determine a loss function to be used for learning based on the time labels and the state label;
a threshold for adjusting a branch condition of the loss-function control unit;
a model implemented at least by the hardware and configured to detect an abnormality or predicting a remaining life span;
a dictionary configured to store a parameter of the model; and
a training unit implemented at least by the hardware and configured to train the model based on the loss function determined by the loss-function control unit.

2. The learning apparatus according to claim 1, wherein the loss-function control unit controls a loss function to be used for learning in such a manner that an abnormality is detected or a remaining life span is predicted within a range in which presence/absence of an abnormality or a remaining life span can be predicted.

3. The learning apparatus according to claim 1, wherein
the data-series group includes data in which the state label is a positive example, and the model is a model for predicting a remaining life span, and
when a remaining life span of each data defined by tracing back by using a time label of data that became a first positive example in the data-series group as a reference is equal to or longer than the threshold, the loss-function control unit defines, as the loss function to be used for the learning, a loss function in which the remaining life span is an objective variable, and
in the case where the remaining life span is shorter than the threshold, the loss-function control unit defines, as the loss function to be used for the learning, a loss function that has a positive value when a value of a remaining life span predicted by using the model is smaller than the threshold and has a zero value when the value is equal to or larger than the threshold.

4. The learning apparatus according to claim 1, wherein
the data-series group includes data in which the state label is a positive example, and the model is a model for predicting a remaining life span, and
when a remaining life span of each data defined by tracing back by using a time label of data that became a first positive example in the data-series group as a reference is represented by T; a value of a remaining life span predicted by using the model is represented by Y; a logical value indicating whether or not data of a positive example is included in the data series is represented by C; and the threshold is represented by θ,
the loss-function control unit defines, as the loss function to be used for the learning, a loss function that has a value corresponding to a difference between Y and T when C=1 and T≤θ, and has a larger one of a value “0” and a value “θ−Y” when C=0 and T>θ.

5. The learning apparatus according to claim 1, wherein the learning unit searches for the threshold based on a performance index of the model.

6. The learning apparatus according to claim 5, wherein the learning unit increases the threshold within a range in which the performance index does not decrease below a predetermined performance index.

7. A learning method comprising:
determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group; and
learning a parameter of a model for detecting an abnormality or predicting a remaining life span based on the determined loss function.

8. (canceled)

9. A prediction apparatus comprising:
an abnormality prediction model by which an abnormality is detected or a remaining life span is predicted by using a parameter of a model, the model having been trained by using a learning apparatus according to claim 1; and
a threshold, wherein
the prediction apparatus is configured to output, for normal data or data having a remaining life span longer than a predetermined value, a value exceeding the threshold, and predict, for abnormal data having a remaining life span equal to or shorter than the threshold, a remaining life span.

10. A prediction method comprising:
detecting an abnormality or predicting a remaining life span by using a model, the model having been trained by determining a loss function to be used for learning based on time labels, a state label, and a threshold for adjusting a branch condition for the loss function, the time labels being pieces of time information each of which is added to a respective one of data included in a data-series group including a data series, the data series being a series of data obtained by observing the same object at discrete times, and the state label being added to at least one of the data included in the data-series group, and learning a parameter of a model for detecting an abnormality or predicting a remaining life span based on the determined loss function; and
outputting, for normal data or data having a remaining life span longer than a predetermined value, a value exceeding the threshold, and predicting, for abnormal data having a remaining life span equal to or shorter than the threshold, a remaining life span.

11. (canceled)
